(19) United States
(12) Patent Application Publication
(10) Pub. No.: US 2010/0250322 A1
(43) Pub. Date: Sep. 30, 2010

(54) SIMPLIFIED USER INTERFACE AND METHOD FOR COMPUTERIZED TASK MANAGEMENT SYSTEMS

(76) Inventor: Michael Roy Norwood, Sedona, AZ (US)

Correspondence Address: STEPHEN E. ZWEIG, 224 VISTA DE SIERRA, LOS GATOS, CA, 95030, US

(21) Appl. No.: 12/749,452

(22) Filed: Mar. 29, 2010

Related U.S. Application Data
(60) Provisional application No. 61/164,186, filed on Mar. 27, 2009.
(60) Provisional application No. 61/217,684, filed on Jun. 3, 2009.

(51) Int. Cl. G06Q 10/00; G06F 3/048; G06F 15/16

(52) U.S. Cl. 705/9; 705/11; 705/301; 715/808; 709/206; 715/764

(57) ABSTRACT

A system, method, and improved user interface for operating a computerized task management database, typically running on a networked server-client system such as the Internet. The system is designed to simultaneously present, on a single user interface screen, often running within a web browser, key items such as the worker (task assignee) name, and key task information items relevant to the various tasks that are assigned to this worker. Such key task information can include, for example, for each given task, the task name or distinguishing task commentary, and an instant update on the status of the task, which will usually contain at least a latest comment field that contains the most recent communication between the task worker and the task manager. The invention conserves user working memory by presenting key comments for multiple tasks on a single screen, enabling better user comprehension of complex projects.

### CROSS REFERENCE TO RELATED APPLICATIONS

This application claims the priority benefits of U.S. Provisional Application No. 61/164,186, filed on Mar. 27, 2009, entitled “System and Method For Facilitating Personal List-Making, Worker Delegation, and Project And Task Management” and U.S. Provisional Application No. 61/217,684, filed Jun. 3, 2009, entitled “Work Focuser/Isolator (applies to previous provisional patent application: “System and method for facilitating personal list-making, worker delegation, and project and task management)”, both of which are incorporated herein by reference.

### BACKGROUND OF THE INVENTION

1. Field of the Invention

The invention is in the general field of user interfaces and methods for operating computer systems, in particular database management systems such as project management systems, task management systems, and other types of computerized collaboration systems.

2. Description of the Related Art

Computerized task management databases, often used for project management and other applications (project management systems) are relatively well known in the art. These computerized systems, which usually exist in the form of computer software that usually runs either on a user's individual (non-networked) computer, or on networked client-server systems are often used to manage complex projects which in turn may have a large number of different tasks. Among other functions, such systems allow managers (here the term “manager” will denote any task assigner) to assign many different tasks to many different “workers” (here the term “workers” will denote the assignee of any task), and manage task and worker progress towards various milestones. Typically such computerized task management software will be run by one or more computer processors, and often make use of (run on top of) other database management software and operating system software to accept, process, store and retrieve relevant project and task data from computer memory, and also display this information to users.

These project management systems typically present information to their users through graphical user interfaces (GUI) on computer display screens, thus creating a user interface. The user in turn will most often input data to the system through common user input devices such as keyboards, mice, touch sensitive screens, trackballs, voice commands, and the like.

Although quite powerful, such computerized project management systems often are difficult to learn to use. Users may have to spend a fair amount of time to become proficient on such systems, and as a result, project management is often regarded as a specialized and rather esoteric art.

### BRIEF SUMMARY OF THE INVENTION

There is thus a longstanding need for simple yet powerful computerized task management databases and project management systems and software that are both easy to learn, and simple enough that non-professional project managers can easily use them.

The invention is based upon the insight that one of the major problems with prior art computerized task management software and systems is that the user interfaces for these prior art systems do not properly take the limitations of human working memory into account.

Projects themselves may be composed of hundreds, thousands, or even hundreds of thousands of individual details and tasks. Such details need to be properly managed, of course, and computers, which can readily handle huge numbers of tasks, are the perfect tool for such problems. Unfortunately prior art project management systems have tended to handle task management by spreading out all of this complexity over large number of user graphical interface display screens. That is, although only one actual user interface on one display screen may be shown to the user at any given time, prior art user interfaces tended to require that the user click (here the action of a computerized mouse or other pointing device will be designated as a “click”) on certain sections of the user interface multiple times in order to go to different screens (away from the original screen) to get an overview of, for example, the status of various tasks that were assigned to any given worker.

Project management is complex, and often the most important aspects of a particular task are captured in the form of correspondence (i.e. “comments”) between workers and managers. These comments are often free-form fields where records of important conversations, email correspondence, instant messaging and the like can be captured and recorded, often in the form of text. In particular, the latest comments pertaining to an individual task, made by any given worker or manager working on that task, are particularly important. These comment updates often quickly summarize key task issues. Comment updates can also go into more depth on some of the more complex task issues that the manager or worker needs to be made aware of. Without such comment fields, important details, that otherwise would not be adequately captured by other data fields on the same screen as the task, would not be captured.

Unfortunately prior art systems did not adequately take into account the limited working memory of the human mind, which can only recall or work with a very small number of different items at any given time (often only about 4 items or so). When this limited working memory is exceeded, human users start to experience confusion, with a resulting loss of efficiency and productivity.

Thus, in one embodiment, the invention is a both an improved user interface and an improved method of operating a computerized task management database. In this improved user interface and method, the system is designed to simultaneously present, on a single user interface screen (the user interface being displayed on a single computer display screen being viewed by the worker or manager), key items such as the worker (task assignee) name, and critical task information items relevant to the various tasks that are assigned to this worker. Such critical task information can include, for example, for each given task, the task name and an instant update on the status of the task, which will usually contain at least a latest comment field that contains the most recent communication between the task worker and the task manager.

A number of other examples and embodiments of the system will also be discussed. This specification should essentially be viewed as being a functional description of the software that implements the invention's improved user interface and method of operating a computerized task management database.

### BRIEF DESCRIPTION OF THE DRAWINGS

FIG. 1 shows a networked computerized client server system, which may allow multiple users to communicate with the task management database software running on a server over a network such as the internet, using typical client computers and web browsers.

FIG. 2 shows examples of different user interface designs. One may tend to overwhelm limited human working memory, while the other is more compatible with limited working memory.

FIG. 3 shows a database manager interface for adding new workers or lists to the database.

FIG. 4 shows an example of how lists of workers may be added to a project and assigned specific hierarchal roles on that project.

FIG. 5 shows the invention's improved user interface operating while a new worker is selected.

FIG. 6 shows the invention's improved user interface operating when the database manager has not communicated with anyone else.

FIG. 7 shows an example of a create/edit screen for tasks.

FIG. 8 shows the invention's improved user interface operating, showing how the invention's improved method links the task latest comment field with other important task information items, allowing the status of many worker tasks to be simultaneously assessed in a single user interface screen without the need for additional clicks.

FIG. 9 shows the invention's improved user interface magnifying or enlarging the critical task comment field, while still allowing the status of many other worker tasks to still be simultaneously assessed (here by the manager) in a single user interface screen.

FIG. 10 shows the task comments screen from the worker's perspective.

FIG. 11 shows an alternative formatted version of the invention's improved user interface (similar to FIG. 8) showing how the invention's improved method links the task latest comment field with other important task information items, and allows the status of many worker tasks to be simultaneously assessed in a single user interface screen. Note that in the original color version of this screenshot, the rows are in alternating colors, such as blue and white.

FIG. 12 shows an alternate embodiment in which the task comment field can be placed into a popup and the selected comment emailed to another person.

FIG. 13 shows an alternate embodiment in which the various workers and tasks may be further arranged into a user privilege hierarchy.

FIG. 14 shows an alternate embodiment in which the various workers and tasks may be further arranged into a user privilege hierarchy and then assigned different roles.

FIG. 15 shows an alternative embodiment in which a new task is being entered into a popup window on top of the single user interface screen.

FIG. 16 shows an example of the task/row prioritizer and re-prioritizer in operation.

### DETAILED DESCRIPTION OF THE INVENTION

This invention is designed to be compatible with the limited availability of “working memory” in the human brain. The invention's improved user interface combines different screens into one screen in a novel manner. The improved user interface works with the limited human working memory, rather than against it (as typical for other prior art systems) and reduces the tendency of the task management software to overwhelm this limited working memory while working on many complex project tasks.

This allows the system user or manager to better get a global view of, for instance, the tasks comprising a project. The result is a much greater efficiency for users to process large amounts of data, particularly as it relates to decision making and task completion.

Working memory is mediated through the brain's “executive functioning” prefrontal cortex. It also is mediated through the posterior parietal cortex, the thalamus, the caudate, and the globus pallidus. The working memory areas of the brain are, essentially, its “hands.” The working memory stores only data that is immediately needed “at hand.” Other data is stored and retrieved from a multitude of other the brain regions, which can be likened to its filing cabinets. However just as it takes more time and effort to retrieve data from a filing cabinet than what is already “in the hands”, when the human brain is forced to turn to longer term memory to retrieve data, confusion can occur, and efficiency can suffer.

Working memory is highly influenced by objects or items in the scope of vision, and can be continually refreshed while an individual is looking at these objects. However once the field of view is shifted to alternative objects, the original objects held in working memory begin to fade within a few seconds, and only those original objects that were successfully transferred to a longer term form of memory can be recalled thereafter.

The invention, in essence, formats the most critical task management data in a user interface designed to be seen at a glance. The resulting visual image allows the information to be directly linked to the limited human working memory. As a result, the data can be continually refreshed in working memory, rather than fade away, because the most critical data remains in the user's field of view. Although, by necessity, clicks to emphasize certain aspects of the data remain necessary for certain management tasks, by having at least one user interface screen designed for “at a glance” refresh of the most critical task management tasks, the invention's computerized task management database can be operated at higher efficiency than prior art.

By contrast, although there are hundreds of other task management systems available, these prior art systems lack such a working memory optimized user interface. Rather, the prior art systems, lacking such a working memory optimized user interface, instead require multiple windows for an individual or a manager to see the complete status on any one task of a project, or to see the entire status on a single project or team member's progress.

For example, these additional windows may require the individual to click away from the main task or project window in order for the user to see all or some of the comments written on a particular task by different workers, or to see the breakdown of all the hours that each individual worker has put into the task, or to see any changes made in Start Dates, Due Dates or Expected Dates of task completion.

In prior art task and project management systems, a single task typically requires a minimum of 3 screen views and 2 clicks to see updates on the task. Thus, for example, prior art systems require:

1) Screen View 1: The task
click 1→
   2) Screen View 2: The latest comment(s)
click 2
   3) Screen View 1 again: The task again.

During this process of viewing different screens and clicking, the brain's working memory is being taxed to correlate the Task's Data in Screen View 1 to the Comment's Data in Screen View 2 {click 1}. Then the newly assimilated Comments Data has to be stored in the brain's limited working memory while the user goes back to Screen View 1 again {click 2) to once again view the Task's Data, while now retaining the Comments Data in working memory.

The limitations of the working memory is taxed even further if, for example, the user then wants to see how many hours he and every other worker has done on a particular task. In this case, for example, the sequence might be:
click 3→

### 4) Screen View 3: Worker 1's Data

click 4→

### 5) Screen View 4: Worker 2's Data

(and additional screen view's if there are more workers)
click 5→

### 6) Screen View 1: The Task Again

Thus, to get an update on any one task, a user needs to go through a minimum of three more screens and potentially six screens or more if the user needs to view additional data such as changes in Start Dates, Due Dates, Expected Dates of Delivery and Percent of work completed each day on the task.

Each Screen View requires additional loads on the user's working memory to the point where the user almost has to have the memory capacity of a Bobby Fisher-like chess champion to keep track of so many moves or different screen interfaces. This taxing of working memory is multiplied even further by every task that comprises a project or an individual's to-do list. This is a skill that can be acquired by experienced project managers with time, but is often beyond the ability of non-professional project managers.

Thus, if there are ten tasks that are currently being worked on in a single project, and each task requires six screen views, the user's working memory has to retain 60 screen views (10 task×6 screens) for a global view of what's happening in that project. If there are 30 current tasks in a single project, then the user's working memory has to retain 180 screen views (30 tasks×6 screens) for a global view of what's happening in that project.

According to brain researcher Noel Cowan (Cowan, N. (2001). The magical number 4 in short-term memory: A reconsideration of mental storage capacity. Behavioral and Brain Sciences, 24, 87-185), 3 or 4 is “the magical number” to the limits of “chunks” of information the average human being can retain in working memory at a given time.

This invention allows the user to reduce those “chunks” or “screens views” down to as little as a single screen view “chunk”. (For example, in one single screen view of the invention, you can see all 30 comments in the project, all the 30 latest comment updates, and all the 30 latest changes or updates on the Start Date, Due Date, Expected Date, % of hours completed on the project and hours spent on the project.). Because this is all displayed on the user interface screen at the same time, the user can see everything at a glance, and the user's limited working memory is continually refreshed and updated by the constant stream of information from the user's eyes.

With the invention, even in viewing historical data on each of the above data points, the user always does so in Screen View 1—the view of all tasks assigned to a single worker, or of all the tasks comprising a single project or subproject. Thus the user's working memory only needs to last as long as the movement of the human eye from the task, to a data point, and back to the task again. This requires a fraction of a second versus the length of time it takes other programs to load the data in the other Screen Views and then later return back to Screen View 1 of the task. Depending upon the speed of the user's internet connection and efficiency of the coding and database construction, this can be many seconds versus the split second required for the invention . . . the literal definition of “as fast as the human eye.”

Also, with the invention, because historical information is loaded in hidden screens in the same database information request action (query) as the task's query, no additional database queries are required to reveal those screens—just a mouse-over or a click with instantaneous appearance of the data.

The net effect of the invention is a huge reduction of the taxing of the brain's working memory. This reduced taxing of working memory results in higher worker performance and productivity, reduced stress and decreased start to finish project time.

Thus in some embodiments, the invention is a user interface (or method of operating) for a computerized task management database that is designed to simultaneously present, on a single user interface screen, a worker name, and various task information items. At a minimum, each task information item will comprise on a per task basis, a task name and at least a task latest comment field. This task latest comment field may, upon mouseover or a click, reveal a historical record of all communications on that task between the worker that is doing the task, and the worker's manager. This all occurs in the same single user interface screen where the task is seen.

Often multiple task information items from multiple tasks assigned to the worker will be displayed on the screen, so that the manager who is operating the database and user interface can see, at a glance, the multiple tasks assigned to the worker, or to a project or subproject, as well as multiple comments as to how these various tasks are proceeding.

In other embodiments, the invention is a user interface (or method of operating) for a network-server computerized task management database. This user interface may often be displayed in a web browser on a remote client computer, and data to and from the interface may be communicated over the Internet using standard http and TCP/IP protocols, and often will further be communicated using Hypertext Markup Language (HTML) or extensions or modifications of HTML. This user interface will simultaneously present, on a single user interface screen of a remote client device, a worker name and task information relating to multiple tasks that have been assigned to the worker. Here, these multiple tasks can include (on a per-task basis), a task name, a task start date, a task priority number, a task percent complete number, and a task latest comment field. As before, this task latest comment field may contain at least the most recent comment in the immediately viewable column. With a click or mouseover, a history of communication may appear between the worker that has been assigned the tasks and the communication of the manager of the worker. All this occurs never leaving the single user interface screen of the task. In this embodiment, the task comment field can be modified or extended on the single user interface screen upon user command. In one preferred formatting embodiment, each different task can be represented as a table row, and the various information items pertaining to the different tasks can be represented as table columns.

In other embodiments, the invention is a user interface (or method of operating) for a network-server computerized task management database that again simultaneously presents, on a single user interface screen (often on a remote client device) a worker name, and various task information items pertaining to the various tasks assigned to the worker. This task information may contain items (on a per task basis) such as a task name, a task start date, a task due date, a task expected date, a task priority number, a task percent completed number and, of course, the very important task latest comment field. As before, this task latest comment field may contain, upon mouseover or clicking, a history of the various communications between the worker and at least one manager of this worker. This task comments field may be magnified or extended on this single user interface upon user command, such as a mouse click, other pointing device, and the like. In a preferred embodiment, each task may be represented or formatted as a table row, and the various task information items can be arranged in table columns. This single user interface screen may additionally display additional information in the form of smaller popup screens on top of the main user interface screen. These additional popup screens can include interfaces to enable new tasks, new notes, worker estimated task time history (the history contains changes), task start date, worker estimated task completion date, task due date, and hours worked history.

In all of the embodiments, in addition to being an improved user interface, the invention can also be viewed as an improved method of operating a computerized task management database with the above various types of user interfaces. This management may include using the above user interfaces to manage at least one of the various tasks assigned to the worker. In other cases, the management may also include other functions as well, such as adding tasks, adding comments, assigning tasks to an alternate worker, adding new workers, deleting workers, downloading one or more tasks from an email, uploading a task to an email, uploading or downloading an attachment to or from the comment or task fields (the attachment, with a click, may also be made viewable on the same single user screen interface), uploading or downloading a task from a calendar, ranking workers according to reliability, quality of work, efficiency of making deadlines, and so on.

In some embodiments the task information items can also include a worker accountability score that can be based on a function of the historical reliability of the worker to, for example, meet task end dates, task expected dates, and make reliable hours estimations for completion of past tasks.

In some embodiments, the task latest comment field can also be sent and received by email or instant messaging.

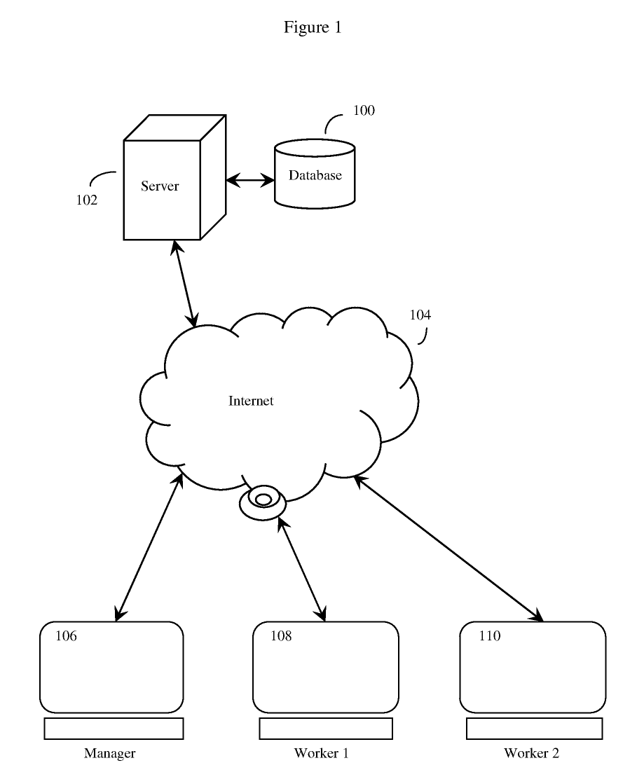

FIG. 1 gives an example of one type of computerized networking hardware environment for the invention. The task management database (100) software and data will often be run on one or more computer processors (microprocessors) and associated memory in a networked server (102). This server will often in turn connect to outside networks, such as the internet (104) and exchange data with one or more client devices, which themselves will often be network capable computers, cell phones, computerized notepads, or other devices. Often the manager(s) of the task management database will work on one set of networked client devices (106), and the workers will work on other sets of networked client devices (108), (110).

In the specific examples shown in this specification, the basic computerized task management software was designed to run on one or more Internet server computers, often referred to as a “cloud” because the servers may be located anywhere on the internet where desired, and the user need not overly care about where the server is actually located. The computerized task management server software was written using Ruby on Rails, and it ran on top of (managed) MYSQL database management software, and used Red Hat Enterprise Linux Server version 5.4 as the operating system. These particular server processors were Dual-Core AMD Opteron™ processors (x86 processors), but of course a wide variety of other processors and processor brands may also be used.

On the client (web browser side), the user interface was written in JavaScript, HTML and made use of Cascading Style Sheets (CSS) and was intended to be run within a standard web browser such as Microsoft Explorer, Firefox, Google Chrome, and the like. This software was thus intended to run in a wide variety of different web browsers and again was also designed to be run on a variety of different client processors, including x86 family processors, ARM processors, power processors, and the like.

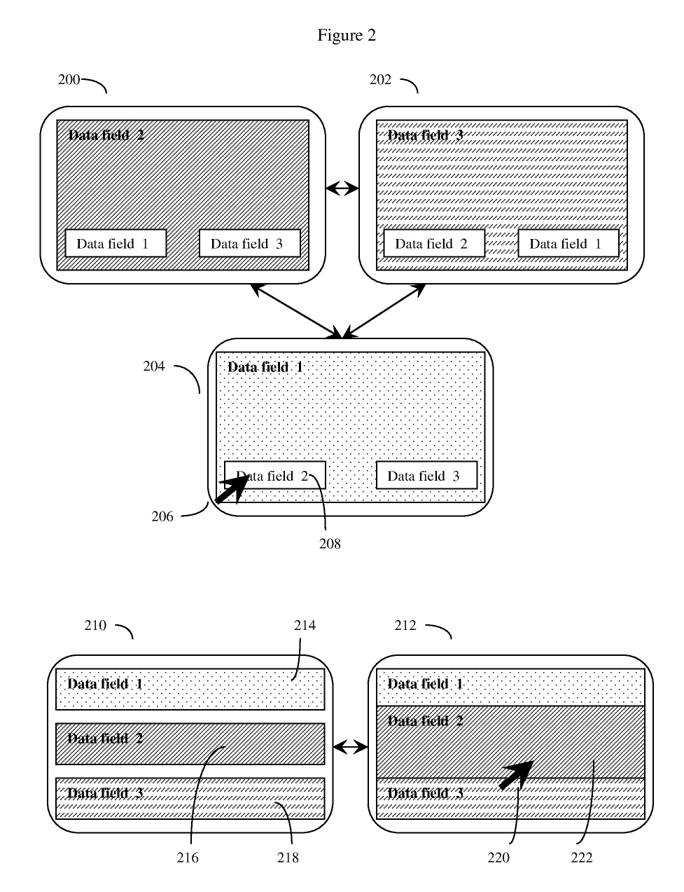

FIG. 2 illustrates how different user interface screen designs can either tend to overwhelm the limited mental working memory of human users, or alternatively can be designed to work within the limited mental working memory of human users. Here (200), (202) and (204) show a typical database system in which different data fields are shown in different user interface screens, and the user interface switches from showing one data field (204) to another data field (200) to another data field (202) depending upon the click of a mouse (206) on various links (208). Although the underlying computer itself can switch between different screens rapidly, the human user of the system will soon suffer from memory overload because the contents of screen (204) will be rapidly pushed out of the limited mental working memory of the user once screen (200) is displayed. Similarly the contents of screen (200) will be rapidly forgotten when the display switches to screen (202).

By contrast, a user interface screen design that does not overwhelm the limited mental working memory of human users is shown in (210) and (212). Here the different database fields (214), (216) and (218) are all shown on the display screen at the same time, and thus are more likely to be retained in the limited mental working memory. A user wishing to find out more about the contents of database field 2 (216), for example, may click a mouse (220) on the field, causing the data field to become enlarged (222) in screen (212) while, at the same time, preserving much of the contents of data field 1 and data field 3 on the screen (212) where they can continue to be seen and used to refresh the limited human mental working memory.

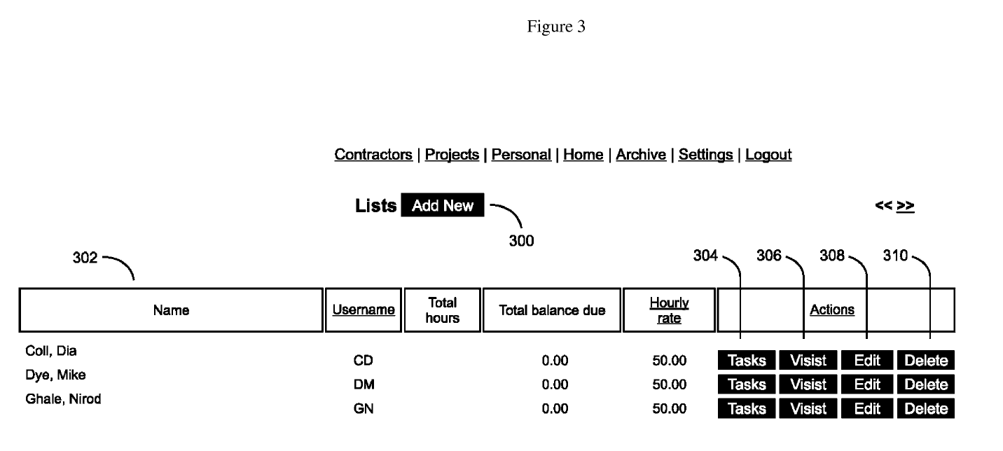

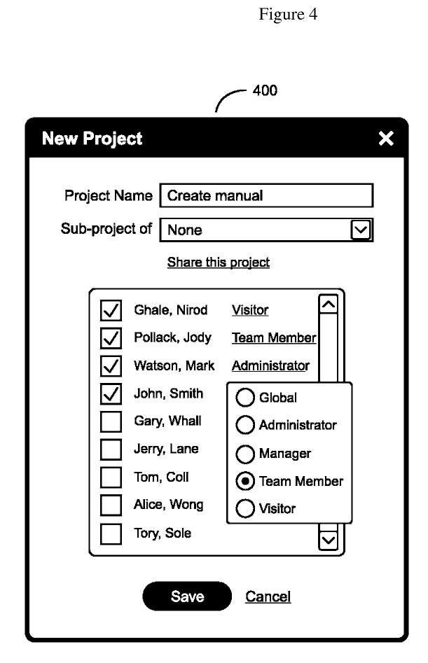

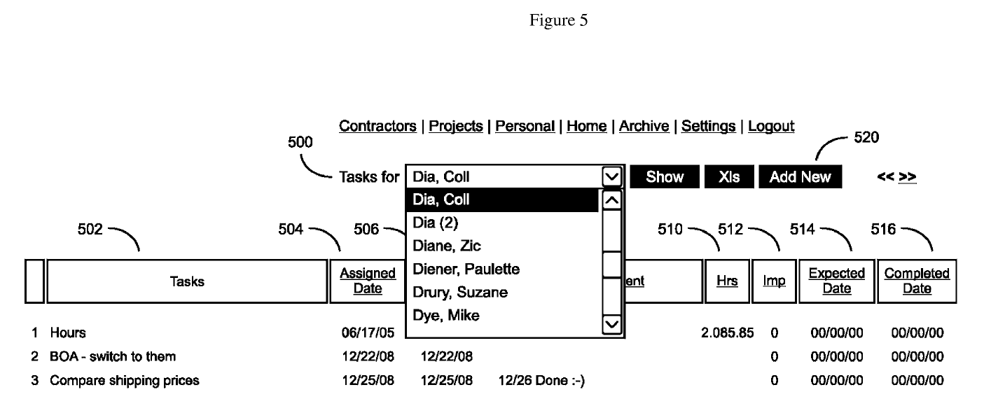

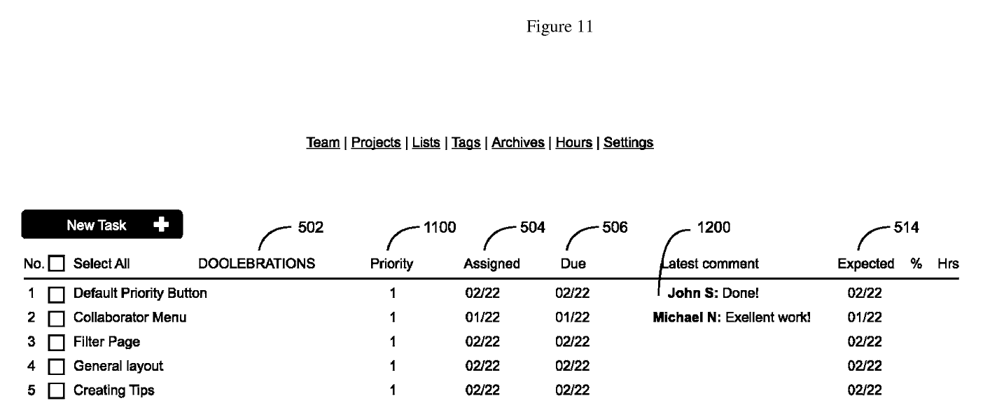

FIG. 3 shows an example of how new workers or other lists may be added to the task database manager. Here an “add new” button (300) can be clicked, for example, to add a new worker to the list (302) of other workers in the database. Other useful function buttons that can be clicked to see other screens may include functions to add tasks (304) (shown in more detail in FIGS. 5, 6, and 8), a button (306) to visit the worker's view of the database (FIG. 11), an edit button (308) to change the input fields regarding this new list or worker (FIG. 4), or a delete button (310) to view this particular worker or list.

FIG. 4 shows an example of the popup screen that can be used to add a new project. Inside the popup screen (400), different roles may be assigned to different collaborators (workers). Each role contains a different set of permissions.

FIG. 5 shows a list screen shot, which begins to show an example of how the invention's improvement of showing a number of key task information items on a single screen can be implemented. Here a particular worker is selected by the pull down menu (500). Note that the task name (502), assigned date (504), part of the due date field (506), part of the latest comment field (506), the number of hours expended field (510), the importance or priority field (512), the expected date (514), and the completed date (516) fields can be seen. Here a different set of task information items (502-516) is given for each worker selected on the pull down menu (500).

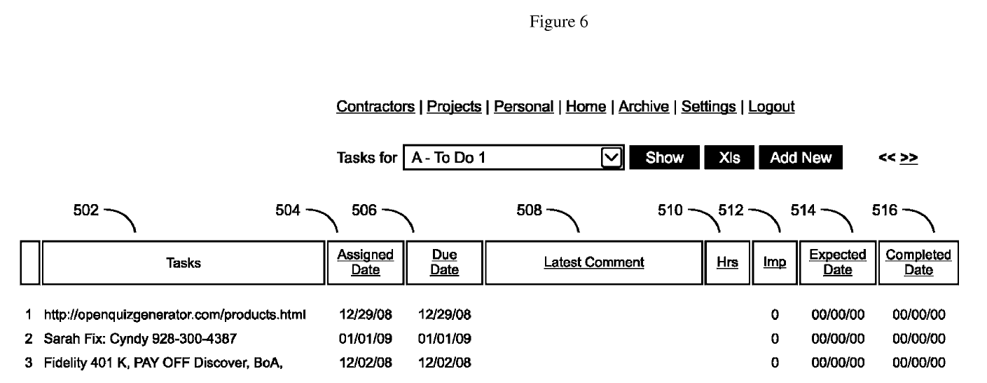

FIG. 6 shows another view of this list screen shot, here no longer obscured by pull down menu (500). In this example, the list screen shot is just the database manager's personal to-do list, so there are no workers (500), and no worker comments in the latest comment field (508).

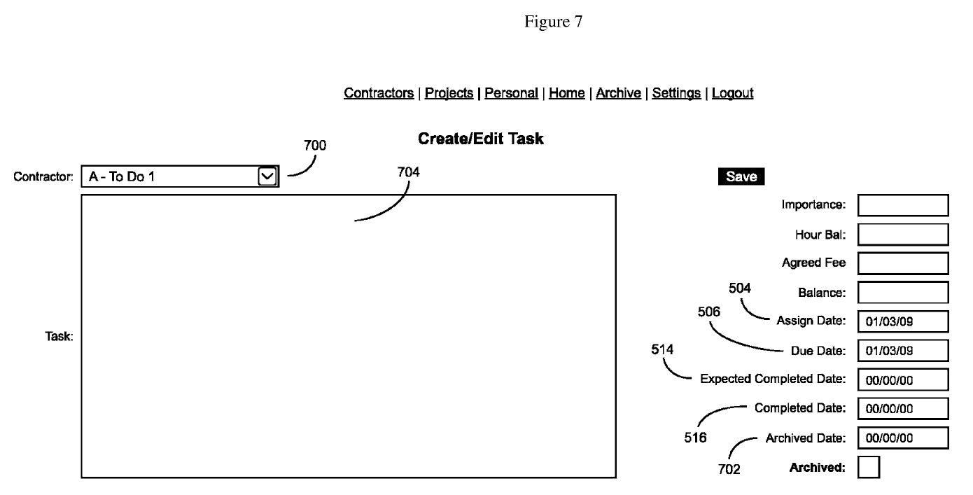

FIG. 7 shows an example of a Create/Edit task screen, which appears when the database manager uses the Add/New button (520) from FIG. 5. This menu also has a worker or contractor list and pull down menu (700) which enables the database manager to assign the task to another worker or contractor. Other fields, such as an assigned date (504), due date (506), expected completed date (514), and a completed date (516), as well as an optional archived date (702), are shown as well. This is where the data for fields (504-516) in FIGS. 5 and 6 can be entered. The new task itself can be entered in box (704).

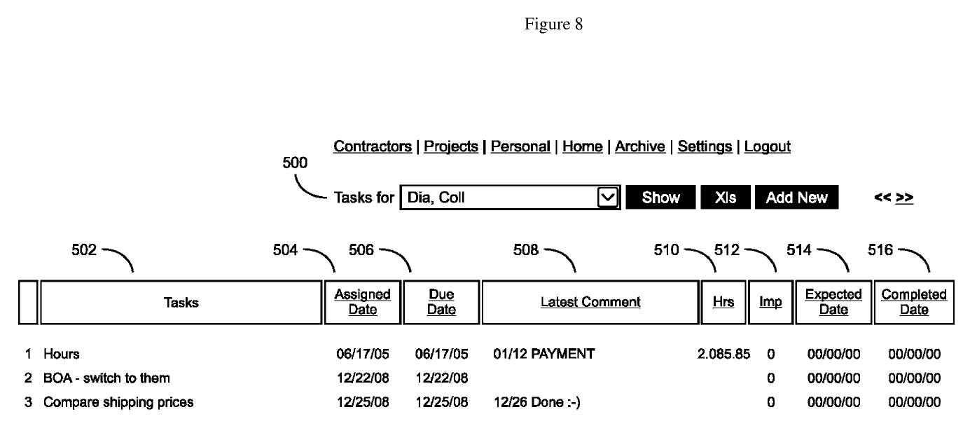

FIG. 8 shows a screen shot similar to FIG. 5, here illustrating one embodiment of what the invention's task management user interface screen may look like when a particular worker 500 is selected. Here the latest comments to (or from) the database manager to the worker, relative to the various tasks (502), may be seen (508). This feature allows the manager to, at a glance, see the worker's latest progress reports (508) for many different tasks in the context of task name (502), assigned date (504), due date (506), expected date (514), completed date (516), and other factors such as importance (512).

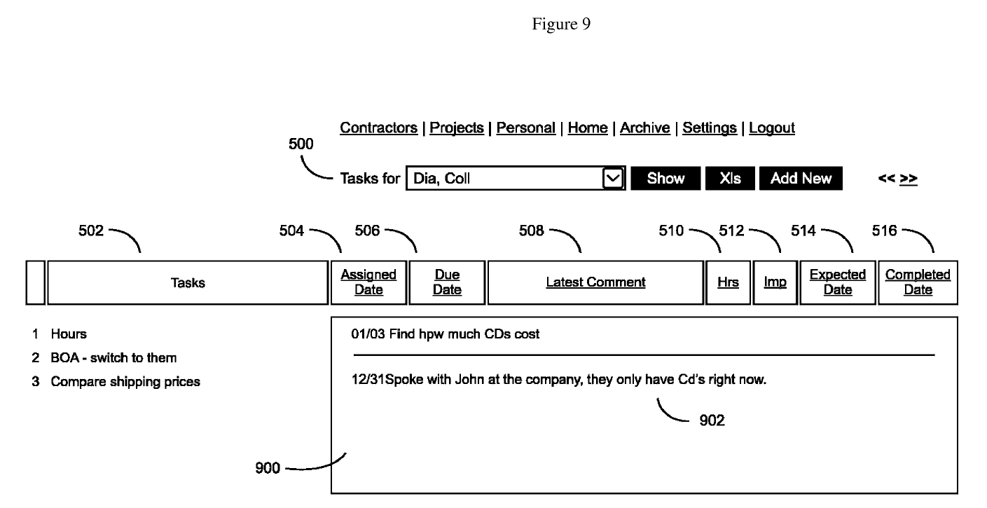

FIG. 9 shows how a manager can easily see a blow-up or magnified view of the worker's comments, still within the overall context of FIG. 8, which thus preserves an overall impression of all of the worker's multiple tasks in the manager's limited mental working memory. Here the manager may, for example, click on or select a particular comment for a particular task (900) and see a magnified or expanded view of the comment field for that task (508), (902) giving a more extensive list of comments for that project going further back in time. The manager may also (not shown) implement an email or instant messenger function and send the latest comment field to the worker or other recipient of the manager's choosing.

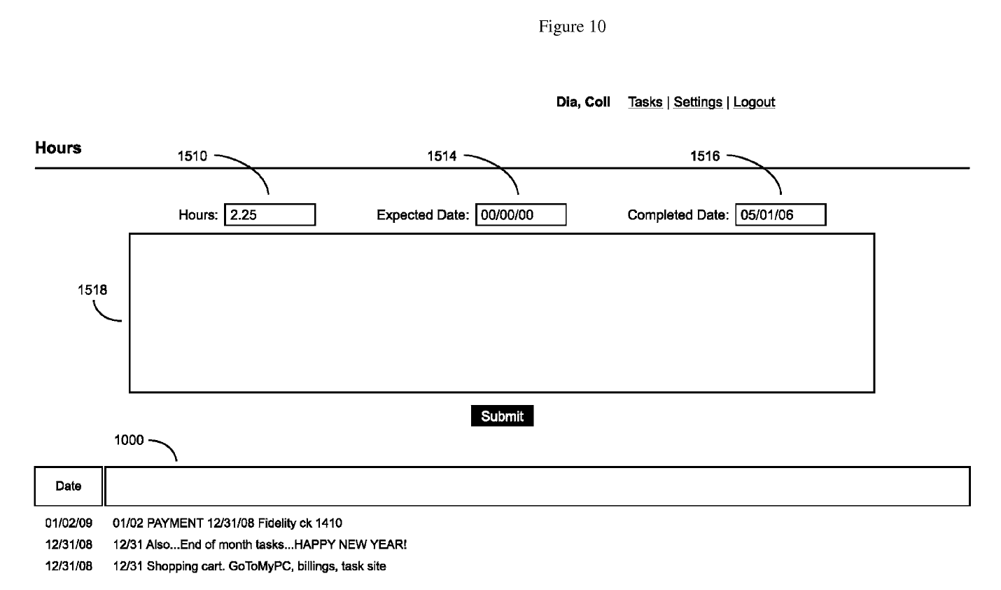

FIG. 10 shows an embodiment of how the create comments screen might appear from a worker's perspective. Here the worker has entered in the hours (1510), expected date (1514), completed date (1516) and comments (1508) that will shortly appear on the manager's screen (FIGS. 5, 8, and 9) as the corresponding data fields (510), (514), (516) and comment field (508) respectively. Here a record of previous worker comments (historical comments) can be seen as (1000).

In some embodiments, unlike the database Manager's comment page (FIG. 9), the worker in FIG. 10 may not be given the ability to Edit or Delete past comments or Expected Dates of task completion that were previously reported. This creates a permanent record that can be used to create a worker accountability score.

Prioritizing task displays on the main user interface:

Another embodiment of this invention “limits” rather than “expands” the components necessary for a user to effectively complete a single time task at a time.

This may seem like a contradiction of the Global View Invention described above, but in fact works completely harmoniously and synchronistic with it. It is, after all, how the brain itself functions: in one moment, taking in all the data and assimilating it via the frontal lobe's association neuron's, which contain more synapses than any other area of the brain. (There can be more than 100,000 synapses per single association neuron). The extraordinarily vast interconnections of these association neurons are what enable a person to see “the big picture.”

However, once The Big Picture is seen, for effective action to take place, the brain's working memory must be called into action. As previously described, here improved user interfaces that allow the user to much more easily hold all the different components of the various tasks in working memory at the same time can speed up the assimilation of data and subsequent decision-making processes.

For maximum working memory functionality on an individual task, however, it is also useful to further isolate tasks or groups of tasks by their relative importance. In some embodiments, this can be done by using additional focusing features that can allow the user to:

1) See only those tasks containing a specified range of priority numbers. For example those tasks that have been given a priority of 1 to 2 (the highest priority tasks whereas lower priority tasks may be given a priority number of anywhere from 2 to 9999). OR
2) See only an exactly specified number of tasks the user inputs (e.g. 1, 2, 3 . . . )

The user can further employ these features to determine what he or she wishes to see on the screen. In a given moment, the user can choose to see hundreds of tasks at a time, or just a single task by using this feature. By contrast, prior art systems tend to use rating systems typically that typically only have a limited number of priority categories, such as High Priority, Medium Priority, and Low Priority, or the categories of Critical, Major or Minor importance.

The problem with these more limited focusing features is there may be dozens of High Priority tasks in a list. Thus, it becomes daunting to see all of these tasks when a user needs to focus on just one or two of the tasks until they are completed. With the Focus View feature of this invention, the user's working memory is again preserved by not having it distracted by everything else that is remaining to be done.

Because of the invention's ability to sort by any column on most pages of the invention, specialized programming may be used to retain the priority numbers assigned to a task. This is particularly true because the priority is often only the secondary sorting feature if a column other than the one containing the priority numbers is chosen as primary sorter.

Having the Priority Column as the automatic secondary sorting feature when another column is chosen as the primary is another important embodiment of this invention because it saves time and working memory resources of the user. For example, if the user sorts first by the % of each task that is completed in descending order (tasks that are most complete at top), the secondary priority order sorting feature allows the user to automatically see the remaining tasks not yet started (0% complete) in ascending order (0-9999) of importance. This allows both worker and manager to know what the subsequent order of next tasks to be worked on should be, all the while staying on the same single user interface screen.

Without the invention's specialized programming, rows assigned the same priority number wouldn't retain their hidden secondary priority sorting number. That is, if five tasks had the priority number of “5”, the system may be programmed as follows to retain the proper sequencing of each of the those Priority 5 Tasks:

### Task 1=5.1

### Task 2=52

### Task 3=53

### Task 4=5.4

### Task 5=5.5

The decimal number however is hidden in the user interface display to simplify the user's view and, once again, be less taxing on the brain's working memory.

An example of this priority function in action can be seen in FIG. 11. Here, in addition to the task name (502) and latest comment fields (508) and other fields (504, 506, 514), (previously described, there is a new priority field (1100) that lists the tasks according to priority order. Here the “Kazeli Shopping cart” task with priority 10 is ranked above the “Direct Impressions” task (which may have had a fractional priority level of 10.1, with the fractional priority number not displayed). Both of these tasks are ranked above the “Pay affiliates mnthy commission” task, which has a priority level of 20.

Further, by selecting an appropriate task with a particular priority score, and dragging and dropping this task to a different location in the display, the system may also automatically assign the “drag and dropped” task a new priority score that is intermediate between the score immediately above the “drag and dropped task”, and the score that is immediately below the “drag and dropped task”. The priority score may also be modified by in-line editing, in which case the task will automatically reposition itself to a location appropriate to its relative priority score.

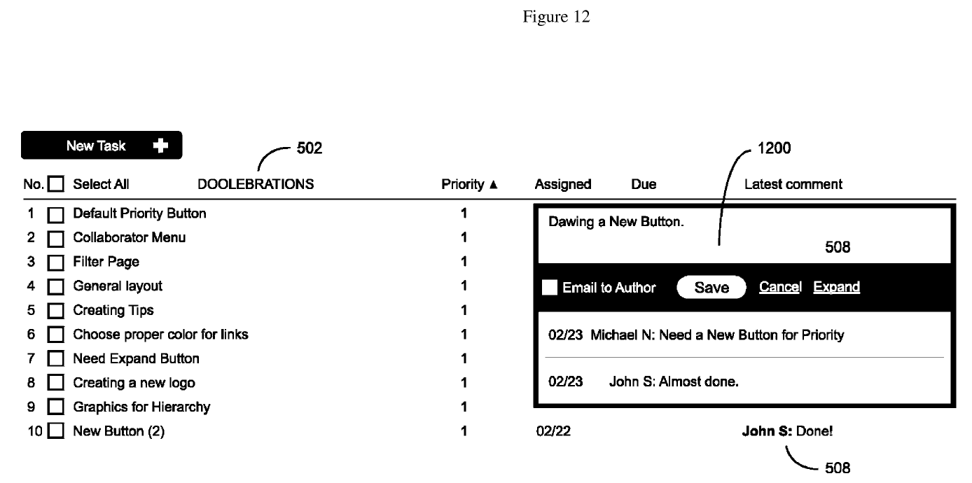

Switching to a different topic, FIG. 12 shows an alternate embodiment of the user interface in which a task comment from the task comment field (508) can be placed into a comment popup (1200) and emailed to another person.

Hierarchy (user privilege) modes:

In some embodiments, the system may additionally have multiple levels of user privilege (hierarchy) control. At the most basic level, the system will often have at least two levels, corresponding to the manager (the person who typically opens the account), and Workers (basically everyone else beside the manager). In contrast to managers, which typically may have access to all system functionality, Workers may typically be only able to update tasks with Comments, Expected Dates, Percent Completion of Tasks and Hours worked on a task.

Other user privilege (hierarchy) modes may differ on a per project basis. Here, on each individual project or subproject, the account holder can assign users either to be a system administrator (full control), Project Manager, Worker, or Visitor (only viewing privileges on the account)

In a full Hierarchal Control embodiment, all new users in the system can be assigned any position created by the account owner in the hierarchy. Each position can be subordinate to any other position and have any desired set of system permissions associated with it. Then each of those permissions can be modified per user once the role is assigned to the user.

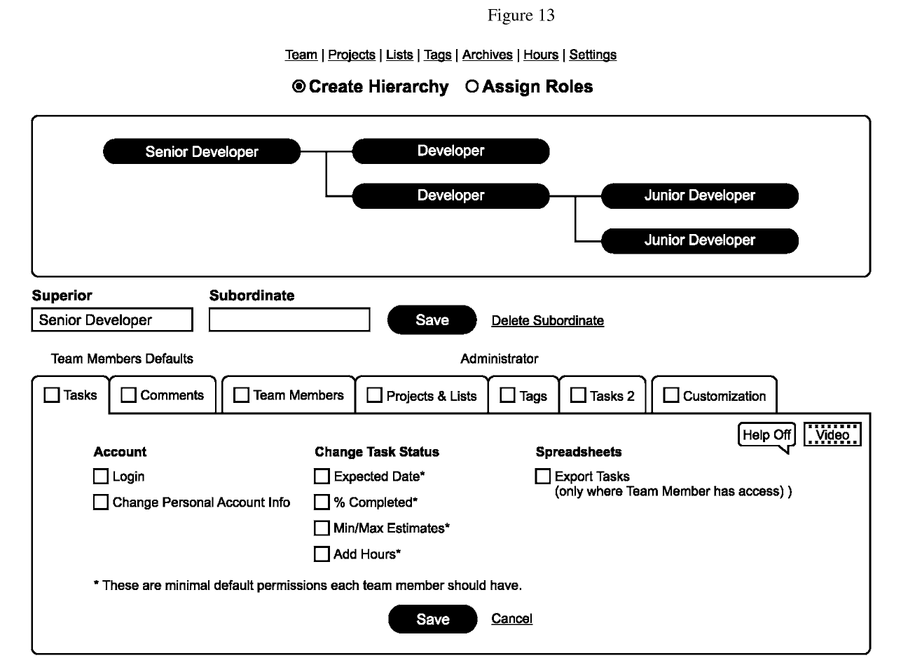

FIG. 13 shows an alternate embodiment in which the various workers and tasks may be further arranged into a hierarchy.

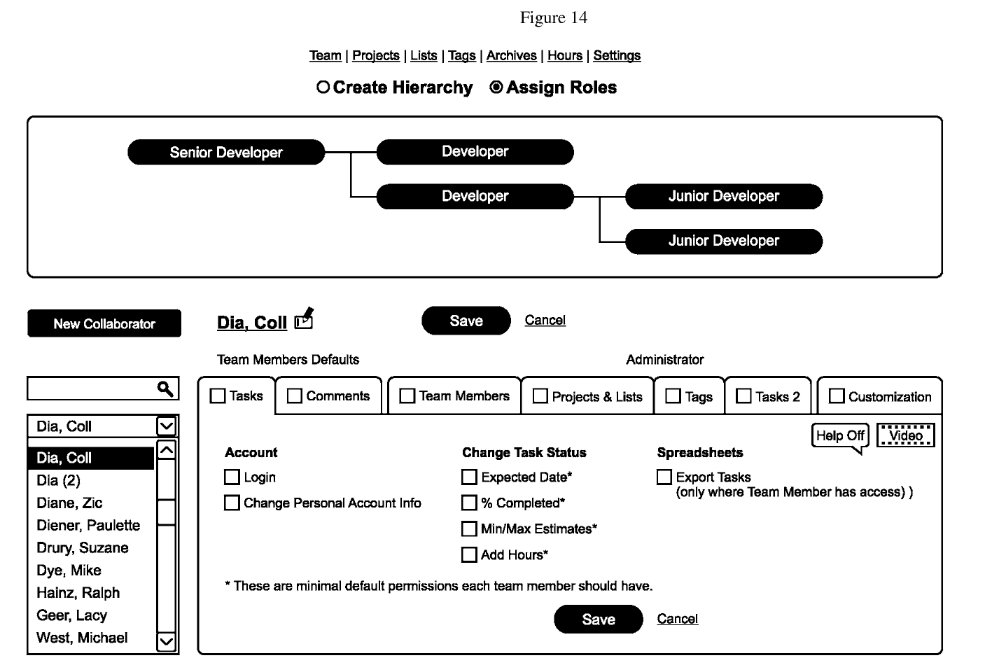

FIG. 14 shows an alternate embodiment in which the various workers and tasks may be further arranged into a hierarchy and then assigned different roles.

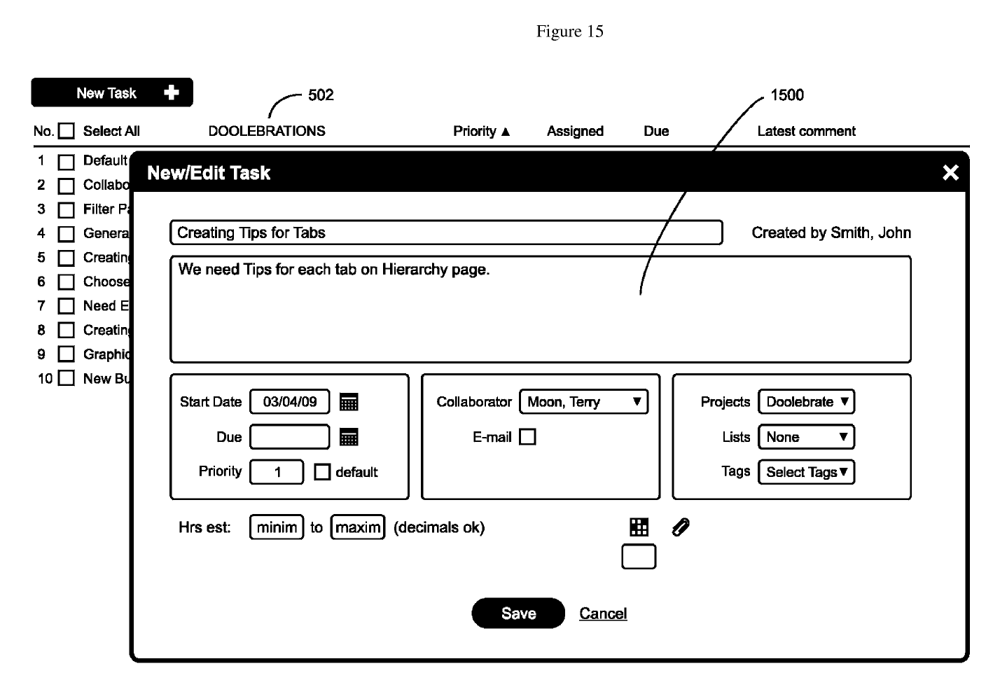

As previously discussed, in alternate embodiments, certain user management tasks may be accomplished by way of popup windows on top of the main user interface screen. FIG. 15 shows an alternative embodiment in which a new task is being entered into a popup window on top of the single user interface screen.

### Task Row Prioritizer and Re-Prioritizer:

As previously discussed, each task, often formatted to be displayed in its own row, may be assigned its own priority number. Often priority levels of various tasks will change. Another embodiment of the invention gives users the flexibility to change the priority of any task appearing on any row by various separate methods, including:

1) Drag n Drop—automatically changes the priority number by averaging it to the numbered priority of the row above and the row below. If placed in top position the priority number will be the current priority number of the top row. If placed in the bottom position the priority number will be the current priority number of the bottom row.
2) Sort by Column—automatically sequentially sorts the rows according to the priority number assigned.
3) In-line editing—priorities can be manually changed by the user to override the current priority. The rows will automatically be resorted according to the new set of priorities. This resorting is unique to this invention.
4) Hierarchy of Sorting—if columns are sorted by due date, assigned date, task name or other columns, then the secondary sorting will be the priority that is assigned.

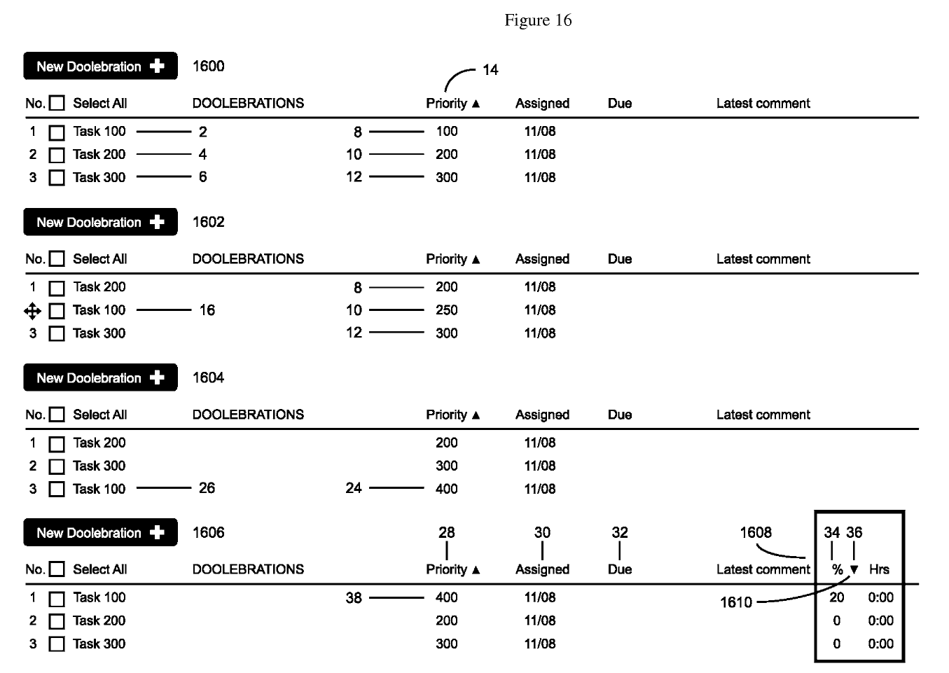

Referring to FIG. 16 (1600), here an end user can name Tasks 2, 4, 6 and assign Numbered Priority 8, 10, 12 to these tasks. The end user can use priority numbers ranging from to 1 to 9999. The tasks are automatically listed in Priority Order 14.

The top row 2/lowest Priority Number 8 indicates highest priority. In FIG. 16 (1600), please note that the task titles are given the same number as the Priority Numbers. This is to more clearly illustrate how those Priority Numbers change in the subsequent FIGS. 16 (1602), (1604), and (1606) described below.

Referring to FIG. 16 (1602), the Drag n Drop feature allows the end user to Select a Task 16 which may be highlighted in a color, such as yellow, and drag the task to a new location (in FIG. 16 (1600) Task 100 was in row 1, now it is in row 2). The task was moved to the second row from the first row 2. The Priority Number 18 has been re-calculated automatically and it is the average of the priority number 20 in the row above and priority number 22 in the row below of the newly assigned location 16 of the task which was moved.

Referring to FIG. 16 (1604), an end user can use in-line editing to change the priority number, and tasks are then automatically arranged according to the New Priority Number Assigned 24. In FIG. 16 (1604), the priority number was changed from 250 (FIG. 16 (1602), item 18) to 400 and automatically repositioned Task 100 to row 3, 26.

Referring to FIG. 16 (1606), there is a hierarchy of sorting of a selected column. The Priority Number Column 28 is secondary for sorting when an end user selects one of the other Columns 30, 32 34, for sorting. Here a % Column 34 (Inset 1608) is the primary column for sorting in this example (as evidenced by the upside Triangle 36 (1610)) and thus the row/task with the highest percentage now appears at the top, and the secondary sorting is the assigned priority number found in the Priority Number Column 28, which is always sorted when in secondary sorting order from lowest to highest. Notice how the First Row 38, which has a priority of 400, is above rows 2 and 3 with lower priority numbers. This is because of the primary sorting by % Column 34 in this FIG. 1606), and by default, the secondary sorting is by Priority Number Column 28.

Additional features:

In addition to the previously described features, other embodiments of the invention may implement additional functionality and features as well. These additional features may include:

Red Warning Indicators: Here dates may turn red (or some other color) when late Due Date or Expected Date is past due. Hours turn red when the worker exceed the maximum hours they estimated for a task. This feature warns the manager and the worker of an area that warrants attention.

Hours Estimate: Here workers can give the minimum to maximum hours they expect a task to take (or manager can assign this range of hours) to a task. This estimate helps a manager to maintain timelines and budgets on a project

These Minimum to Maximum hours estimates can be seen in a single screen search for each user or project. The manager can then, for instance, see all the archived or un-archived tasks on a project with a total Minimum and Maximum range to see how much more time and subsequently, how much more money, each project will require.

Hours Tracking: Here the worker may enter the number of hours each day they work on a particular task. Each task and the cumulative number of hours they have worked may appear on a screen where the manager can see every task that worker has ever done on a day by day basis.

Additional functions may also include:

Lists: Lists may function in a manner similar to Projects, but are a separate menu item for easier classification. Lists may be things such as Shopping List, Books I've Read, Movies I've Seen, Favorite Quotes, and so on.

Subprojects: Each new project created may be designated a subproject of another project

Gantt Charts: The system may additionally create a Gantt Chart based on data entered on each task indicating that task's “dependency” on the completion of other tasks to complete that original task.

Formatting: Alternating Row Colors—each row (often each row is a different task) may be alternate colors. For example, different rows may be alternatively colored blue, white, blue, white for easier reading of the row's contents.

Title/Description: Each task can be given a short title and a longer description, and this may often be color coded for easier reading. For example, the task title may appear in blue on the rows for quicker perusing of all tasks without reading the entire task. (Less data to be kept in the user's working memory). Other features can allow users to view any single screen according to different selections, such as: Titles Only, Titles and the first paragraph of each task's description, Titles and the entire description of each task, and so on.

Action Boxes: In some embodiments, when one or more tasks are selected via a checkbox, one or more action box may pop up (alternatively called popups) allowing any of the following actions to occur on the selected task(s). These actions can include:

1_ Apply a “Tag”: This feature may apply a “tag” or “label” to that group of tasks as a more granular sorting method for tasks or List notes found anywhere in the system. These tagged tasks can be viewed on one single screen when a particular Tag is selected in the Tag menu.
2_ Move To: This feature may move any task or group of tasks to a particular project, list, collaborator or Tag no matter where the task(s) was originally found.
3) Copy To: This feature may copy any task or group of tasks to a particular project, list or collaborator no matter where the task(s) were originally found, while keeping the original task or group in the original location. The copied tasks function completely independently from the original task(s).
4) Pending: This feature may move any task or group of tasks to a Pending Screen of that particular project, list or collaborator. Pending tasks are those where an action is completed but is waiting for another action other than from that worker to be completed, and later archived. (This function has similar functionality as in a Gantt Chart, but Gantt Charts usually deal with groups of dependent tasks, where here a single task can be assigned to the Pending Screen).
5) Archive: This feature may move any task or group of tasks to the Archived Screen of that particular project, list or collaborator. Archived tasks are typically those that have been marked 100% completed in the Percent Completed column.
6) Delete: This feature may delete any task or group of tasks from the system's memory.
7) Color Row: This feature may allow the user to color a row via a color picker. Colored rows can bring more attention to the row, or can be used instead of Tags to identify a group of tasks with similar characteristics.
8) Calendar: This feature may allow the user to place any task or group of tasks on a calendar according to each task's previously designated Start Date or Due Date, or the Start Date or Due Date assigned to those group of tasks in this action box Calendar function itself.

Other embodiments: In other embodiments of the invention, any page may be made into a spreadsheet and saved in a separate spreadsheet format, such as a Microsoft Excel format.

Task or comment fields: Any number of attachments can be inserted into any task or comment field, and these attachments may be viewed on the same single user screen interface as the other task data fields. These attachments may optionally be sent to other users by email, instant messaging, or other methods.

Although certain specific embodiments of the invention's computerized task management user interface, as well as specific aspects of the invention's method of operating a computerized task management database have thus been supplied, it should be understood that these specific examples and embodiments are not intended to be limiting. Certain extensions and generalizations of the concepts in this specification will also be apparent to those skilled in the art.

1. A method of operating a computerized task management database, comprising:
simultaneously presenting on a single user interface screen, a worker name, and task information items pertaining to a plurality of tasks assigned to said worker;
said task information items comprising, on a per task basis, a task name, and a task comment field;
said task comment field comprising communication between said worker and at least one manager of said worker;
and managing at least one of said plurality of tasks assigned to said worker using said single user interface screen.

2. The method of claim 1, wherein said task comment field further comprise a history of communication between said worker and at least one manager of said worker, and wherein said task comment field is magnified or extended on said single user interface screen upon user command.

3. The method of claim 1, further setting the number of task information items simultaneously presented on said single user interface screen to a value between 1 and the full number of said plurality of tasks assigned to said worker.

4. The method of claim 1, in which the task information items further comprise a task priority number;
further setting the number of task information items simultaneously presented on said single user interface screen according to the value of said task priority number;
and if said task is selected and dragged to a different task priority location, automatically recalculating the task priority number to a value intermediate between tasks above said different task priority location, and tasks blow said different task priority location.

5. The method of claim 1, in which said task information items further comprise a worker accountability score based on a function of the historical reliability of said worker to meet task end dates, task expected dates, and hours estimations for past tasks.

6. The method of claim 1, wherein said task comment field can send and receive comments by instant messaging or email.

7. The method of claim 1, wherein each task is represented as a table row, and the task information items are represented as table columns.

8. The method of claim 1, wherein said single user interface screen further displays additional information selected from the group consisting of new tasks, new notes, worker estimated task time, task start date, worker estimated task completion date, task due date, hours worked, task start date, task due date, task expected date and a task percent completed number superimposed on said single user interface screen in the form of popup screens.

9. The method of claim 1, in which said task information items further comprise the number of hours a worker or workers have spent on a task.

10. The method of claim 1, in which managing at least one of said plurality of tasks assigned to said worker comprises functions selected from the group consisting of adding tasks, adding comments, assigning tasks to an alternate worker or alternate project or subproject, adding workers, deleting workers, downloading a task from an email, uploading a task to an email, downloading a task from a calendar, uploading a task to a calendar, and ranking workers.

11. The method of claim 1, in which said database resides on a networked server device, and in which the user interface is displayed on at least one remote client device.

12. The method of claim 1, in which said task comments field is a task latest comments field.

13. A method of operating a network-server computerized task management database, comprising:
simultaneously presenting on a single user interface screen of a remote client device, a worker name, and task information items pertaining to a plurality of tasks assigned to said worker;
said task information items comprising, on a per task basis, a task name, a task start date, a task due date, a task priority number, a task percent completed number, and a task comment field;
said task comment field comprising communication between said worker and at least one manager of said worker;
wherein said task comment field further comprises a history of communication between said worker and at least one manager of said worker, and wherein said task comment field is magnified or extended on said single user interface screen upon user command;
wherein each task is represented as a table row, and the task information items are represented as table columns;
and managing at least one of said plurality of tasks assigned to said worker using said single user interface screen.

14. The method of claim 13, further setting the number of task information items simultaneously presented on said single user interface screen according to the value of said task priority number.

15. The method of claim 13, in which said task information items further comprise a worker accountability score based on a function of the historical reliability of said worker to meet task end dates, task expected dates, and hours estimations for past tasks.

16. The method of claim 13, wherein said task comment field can send and receive comments by instant messaging.

17. The method of claim 13, wherein said single user interface screen further displays additional information selected from the group consisting of new tasks, new notes, worker estimated task time, worker estimated task completion date, task due date, and hours worked superimposed on said single user interface screen in the form of popup screens.

18. The method of claim 13, in which managing at least one of said plurality of tasks assigned to said worker comprises functions selected from the group consisting of adding tasks, adding comments, assigning tasks to an alternate worker, adding workers, deleting workers, downloading a task from an email, uploading a task to an email, downloading a task from a calendar, uploading a task to a calendar, and ranking workers.

19. A method of operating a network-server computerized task management database, comprising:
simultaneously presenting on a single user interface screen of a remote client device, a worker name, and task information items pertaining to a plurality of tasks assigned to said worker;
said task information items comprising, on a per task basis, a task name, a task start date, a task due date, a task expected date, a task priority number, a task percent completed number and a task comment field;
said task comment field comprising communication between said worker and at least one manager of said worker;
wherein said task comment field further comprises a history of communication between said worker and at least one manager of said worker, and wherein said task comment field is magnified or extended on said single user interface screen upon user command;
wherein each task is represented as a table row, and the task information items are represented as table columns;
wherein said single user interface screen further displays additional information selected from the group consisting of new tasks, new notes, worker estimated task time, task start date, worker estimated task completion date, task due date, and hours worked, superimposed on said single user interface screen in the form of popup screens;
managing at least one of said plurality of tasks assigned to said worker using said single user interface screen;
wherein said managing comprises functions selected from the group consisting of adding tasks, adding comments, assigning tasks to an alternate worker, adding workers, deleting workers, downloading a task from an email, uploading a task to an email, downloading a task from a calendar, uploading a task to a calendar, and ranking workers.

20. The method of claim 19, in which said task information items further comprise a worker accountability score based on a function of the historical reliability of said worker to meet task end dates, task expected dates, and hours estimations for past tasks.
